(19) United States
(12) Patent Application Publication
(10) Pub. No.: US 2009/0009667 A1
(43) Pub. Date: Jan. 8, 2009

(54) KEY CHAIN DISPLAY DEVICE

(76) Inventor: Maurice S. Dayan, Oakhurst, NJ (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 12/041,431

(22) Filed: Mar. 3, 2008

Related U.S. Application Data
(60) Provisional application No. 60/892,327, filed on Mar. 1, 2007.

(51) Int. Cl. H04N 5/64

(52) U.S. Cl. 348/838; 348/E05.128

(57) ABSTRACT

A display device that is able to have a key chain alternately attached and detached therefrom. The display device is able to receive digital data from an external device and display the data on its screen. The display device further has an easel that is able to support the display device so that it may be viewed with ease when placed on objects, such as a desks and tabletops.

### CROSS-REFERENCE TO RELATED APPLICATIONS

The present application claims the benefit of U.S. Provisional Application Ser. No. 60/892,327 filed on Mar. 1, 2007, the entirety of which is hereby incorporated by reference.

### FIELD OF THE INVENTION

The present invention relates generally to the field of digital picture displays, and more particularly to a combined keychain and table top digital picture frame.

### BACKGROUND OF THE INVENTION

Much of today's digital media is placed within MP3 players and other compact digital devices. These digital devices are frequently moved from place to place and carried around casually. Losing these devices sometimes occurs due to neglect or placement at an obscure location. Therefore there is an increasing need for a convenient way to use and handle digital media devices.

Also, while digital media devices, such as video, image and MP3 devices may be carried from place to place there is no effective way to set up these devices and conveniently view them. Therefore, there is a need for an effective way in which to arrange or set-up digital media devices for viewing.

Therefore there is a need in the field for an easily transportable and displayable image devices.

### SUMMARY OF THE INVENTION

It is therefore an object of the invention to provide a display device that is both easily transportable and displayable.

Another object of the invention is to provide a display device usable as a key chain.

Yet another object of the invention is to provide a display device that is able to receive digital image data.

In accordance with these and other objects of the invention an aspect of invention can be a combined keychain and digital picture frame comprising: a body comprising a front surface and a rear surface; a display screen provided on the front surface; an easel pivotally attached to the body so as to be moveable between a retracted position and a support position; a chain having a first end and a second end, the first end comprising a first connection member; a key ring connected to the second end of the chain; a second connection member in the body; wherein the first and second connection members are adapted to alternately attach and detach with each other; and a controller operably connected to the display screen, the controller adapted to process an image file for display on the display screen.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof and to the accompanying descriptive matter, in which there is illustrated and described a preferred embodiment of the invention.

### BRIEF DESCRIPTION OF THE DRAWINGS

FIG. 1 is front view of the display device in accordance with an embodiment of the present invention.

FIG. 2 is a rear view of the display device and support member in a retracted position, in accordance with the embodiment shown in FIG. 1.

FIGS. 3a and 3b are side views of the display device in accordance with the embodiment shown in FIG. 1.

FIG. 4 is a front view of the display device illustrating the removal of the key chain, in accordance with the embodiment shown in FIG. 1.

FIGS. 5a and 5b are views of the display device with the support member placed in the support position, in accordance with an embodiment of the present invention.

### DETAILED DESCRIPTION OF THE DRAWINGS

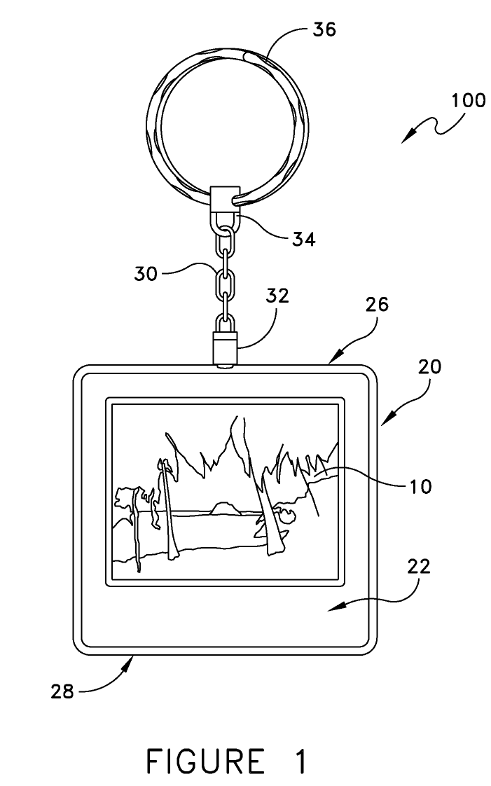

Referring to FIG. 1, a front view of the display device 100 in accordance with an embodiment of the present invention is shown. The display device 100 is a combined keychain and digital picture frame for displaying an image file such as digital images produced using a digital camera. The display device 100 permits a user to attach the display device to a set of keys and detach the display device from the keys in order to display the photographs on a table top. The display device 100 employs a memory storage capability so that a plurality of images may be displayed in the display device 100, as will be discussed in further detail below.

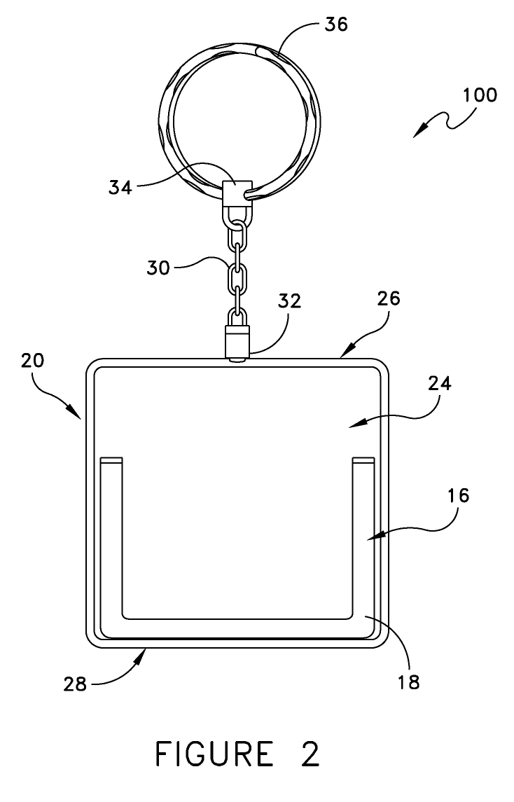

The display device 100 comprises a body 20 having a front surface 22, a rear surface 24 (shown in FIG. 2), a top surface 26 and a bottom surface 28. The body 20 is rectangular in shape. It should be understood however, that other shapes and configurations may be used to form the body 20, including, without limitation, oval, square, heart, oblong, octagonal, etc. The body 20 is made of molded plastic and may include a decorative finish, style and color. Other materials may also be used however.

The display device 100 further comprises a display screen 10 located on the front surface 22 of the body 20. The display screen 10 is a flat panel liquid crystal display (LCD) that is at least 1.5 inches in size. The invention is not so limited, however, and the size of the display screen 10 may vary, and any other known display type of screen may be used including passive display, active display, etc.

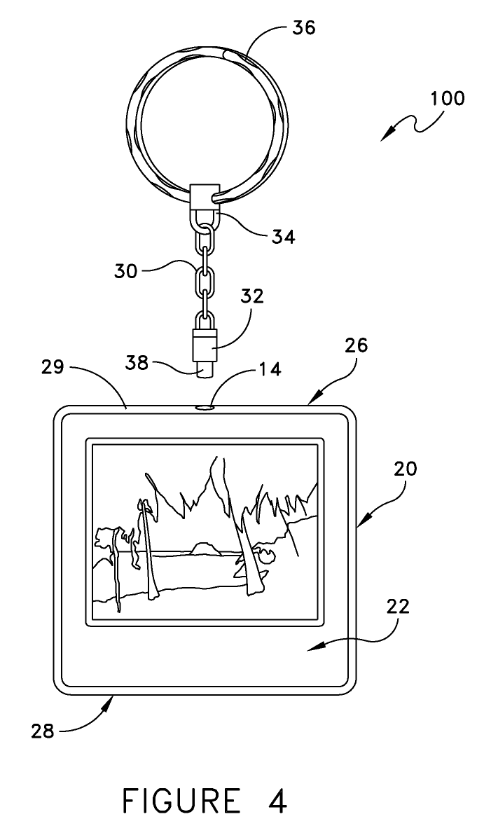

The display device 100 further comprises, a chain 30 extending from the top surface 26 of the body 20. The chain 30 comprises a first end 32 and a second end 34. The first end 32 is in surface contact with the top surface 26 of the body 20. A ring 36 is attached to the second end 34 of the chain 30. Typically the ring 36 is intended to be used for attaching keys to the ring 36. As will be discussed with reference to FIG. 4, the first end 32 of the chain 30 comprises a first connection member 38 (shown in FIG. 4) which connects with a second connection member (not illustrated) in the body 20 and is adapted to alternately attach and detach therefrom.

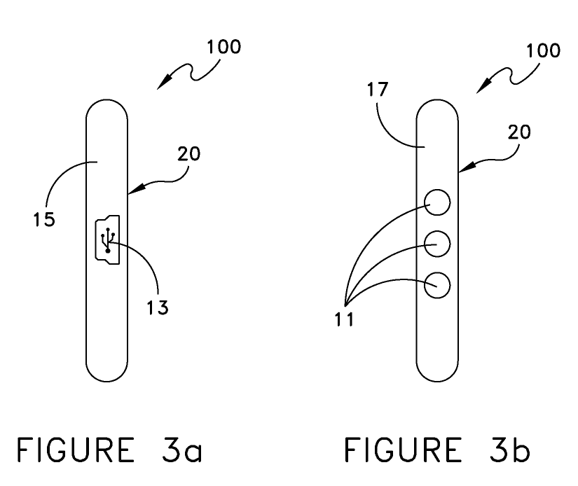

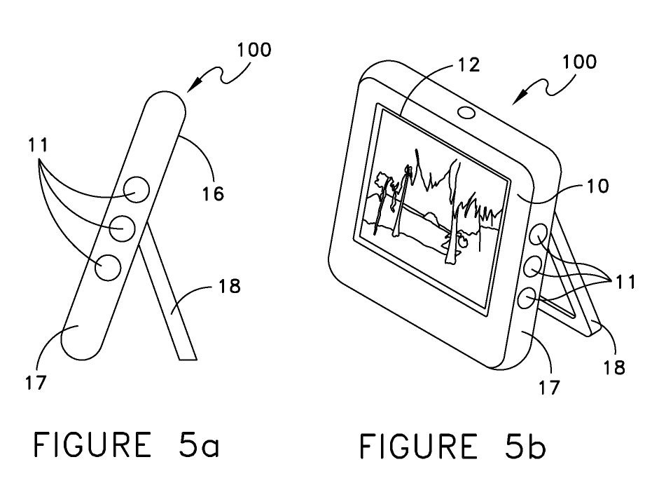

FIG. 2 is a rear view of the display device 100, according to one embodiment of the present invention. The display device 100 further comprises an easel 18 attached to the body 20. The easel 18 is pivotally attached to the body 20 so as to be moveable between a retracted position as shown in FIG. 2 and a support position (shown in FIG. 5A). Although the easel 20 is shown pivotally connected to the rear surface 24, the invention is not so limited and the easel 18 could be pivotally connected to the sides 15, 17 (shown in FIGS. 3A and 3B) of the body 20. When the easel 18 is in the retracted position, it is folded into a recess (not visible) in the rear surface 24 of the body 20 so that the display device 100 is easily transportable. Furthermore, when the easel 18 is in the retracted position the outer surface 16 of the easel 18 is co-planar with the rear surface 24 so that a substantially uniform surface is created. It should be understood that while in the embodiment shown the outer surface 16 of the easel 18 flush with the rear surface 24 of the body 20 when it is in the retracted position, it is possible to have the outer surface 16 of the easel 18 protrude from the rear surface 24. Additionally, the bottom surface of the easel 18 may extend beyond the bottom surface 28 of the body 20.

FIGS. 3a and 3b are side views of the display device 100 in accordance with the embodiment shown in FIG. 1. On the first side 15 of the body 20, a USB port 13 is provided in order to receive data from an external device. The external device may be a camera, video camera, personal computer, CPU) etc. It should be understood that although a USB port 13 is shown it is possible to have other types of ports provided for the reception of data from external devices, such as firewire cables, memory sticks and/or SD cards. When a USB cable is inserted into the USB port 13 the data stored on an external device is transmitted to the display device 100. Data transmitted from an external device is taken by a controller and processed in order to display an image file/data on the display screen 10. The controller can be a suitable microprocessor based programmable logic controller, chip, or the like for process control. The data may be in any acceptable format that can accommodate image data, video data and or music/sound data, such as JPG, GIF, etc. The display device 100 further comprises memory so as to have the capacity to store a certain amount of data, i.e. in order to store a specific number of pictures, videos, songs and the like. The amount of memory is limited by space constraints, however, at least 8 MB of memory is supplied in the display device 100. More or less memory may be provided as needed and as permitted by the space constraints.

On the second side 17 of the body 20, a plurality of controls 11 are provided in order to manipulate the image shown on the display screen 10, such as presentation of the image, moving forward and backwards through a list of photos, power, contrast, brightness, etc. The controls 11 can also be used to manipulate the presentation of other data, such as volume, etc. When a user operates the controls 11, instructions are sent to the controller and the controller processes the data in order provide the proper image to the screen 10 and/or to manipulate the control of the screen 10 or the data. Pictures can be viewed in either a manual control mode or an auto mode. Where the display device 100 is in manual control mode, the user must push one of the control buttons to scroll through the images/digital pictures. Where the display device 100 is in auto mode, the controller causes the pictures to automatically scroll after each picture has been displayed a predetermined amount of time. The display device 100 may further be programmed with an automatic shut down after a predetermined amount of time has passed without the controller receiving input from the user.

The display device 100 further comprises a rechargeable lithium battery. An external power source may be connected to the display device 100 so as to recharge the battery. Additionally, the USB port may be used to connect the display device 100 to a computer so as to recharge the battery.

FIG. 4 is a front view of the display device 100 with the chain 30 detached from the body 20, in accordance with one embodiment of the present invention. The chain 30 is alternately attached and detached from the body 20 by utilizing the first connection member 38 and the second connection member (not visible) in the body 20. The first connection member 38 is at the first end of the chain 30. The invention is not so limited, however, and the first connection member 38 could protrude from the body 20 and the first end 32 of the chain 30 would then comprise the second connection member. The first connection member 38 is formed as a pin, but the invention is not so limited and the first connection member 38 could be a tang, a hook, a ring, a screw and any other object capable of being mechanically attached and detached from a second object without destroying the two objects. In the illustrated embodiment, the second connection member comprises a receiving slot 14 for slidably receiving the pin/first connection member 38. Within the receiving slot 14 is a snap lock type mechanical locking device operably connected to a release mechanism/push button 29 for quickly and cleanly deactivating the locking device so that the chain 30 and the body 20 may be detached from each other. In other words, the first connection member 38 is slidably inserted into the receiving slot 14 so that the first connection member 38 is held in place by, for example, a block and/or protrusion within the slot 14 that keeps the first connection member 38 from sliding out of the slot 14. The block/protrusion within the slot 14 is mechanically connected with the push button 29. The push button 29 is accessible to a user on the outer surface of the body 20 and when the push button 29 is pushed by a user, the block/protrusion is moved so as to create an opening through which the fast connection member 38 may slide out of the slot 14. Thus, the first connection member 38 and the second connection member are detached from each other. Snap lock type fasteners as described above are well known in the art. Other means for attachment may be used, including snaps, clasps, hooks, hook and loop tape, friction type fasteners etc. The display device 200 may alternatively comprise a first ring that protrudes from the top surface of the body 20 and engages with a second ring on the first end 32 of the chain 30. In such an embodiment, the push button 29 is not necessary and the rings are attached and detached manually by a user in the same way that keys are attached to a keyring. Furthermore, it should be understood that it is possible to have the chain 30 be permanently attached to the display device 100.

FIGS. 5a and 5b are views of the display device 100 with the easel 18 placed in the support position, in accordance with an embodiment of the present invention. As shown, the easel 18 is pivotally attached to the body 20 of the display device 100. When placed in the support position, the easel 18 is angled so that it can support the weight of the display device 100. As shown, the support member 18 is rectangular in shape, however it should be understood that other shapes are possible so long as the display device 100 is supported so that it easy to view the display screen 10 when it is positioned on a table top or other flat surface. For example, the easel 18 may be triangular in shape with the base of the triangle being used to support the display device 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A combined keychain and digital picture frame comprising:
a body comprising a front surface and a rear surface;
a display screen provided on the front surface;
an easel pivotally attached to the body so as to be moveable between a retracted position and a support position;
a chain having a first end and a second end, the first end comprising a first connection member;
a key ring connected to the second end of the chain;
a second connection member in the body;
wherein the first and second connection members are adapted to alternately attach and detach with each other; and
a controller operably connected to the display screen, the controller adapted to process an image file for display on the display screen.

2. The combined keychain and digital picture frame of claim 1 further comprising an input port for connecting to an external device.

3. The combined keychain and digital picture frame of claim 1 further comprising a release mechanism for detaching the first and second connection members from each other.

4. The combined keychain and digital picture frame of claim 1, wherein the body further comprises a recess and wherein when the easel is in the retracted position, the easel is housed within the recess.

5. The combined keychain and digital picture frame of claim 1 further comprising a plurality of controls for manipulating the presentation of the image file.

6. The combined keychain and digital picture frame of claim 1 wherein the display screen is equal to or less than 1.5 inches in size.

7. The combined keychain and digital picture frame of claim 1 wherein the display screen is an LCD screen.

8. The combined keychain and digital picture frame of claim 1 further comprising a memory for storing and managing the image file.

9. The combined keychain and digital picture frame of claim 8 wherein the memory is in an external device.

10. The combined keychain and digital picture frame of claim 1 further comprising a speaker, and wherein the controller is further adapted to process sound files for projection through the speaker.

11. The combined keychain and digital picture frame of claim 1 barter comprising a rechargeable lithium battery.

12. The combined keychain and digital picture frame of claim fluffier comprising a plug for connection to an external power source.
